(19) United States
(12) Patent Application Publication
(10) Pub. No.: US 2010/0104815 A1
(43) Pub. Date: Apr. 29, 2010

(54) Plastic product and method for manufacturing the same

(75) Inventor: Shu-Chen Lin, Taoyuan County (TW)

Correspondence Address: RABIN & Berdo, PC, 1101 14TH STREET, NW, SUITE 500, WASHINGTON, DC, 20005, US

(73) Assignee: Quanta Computer Inc., Taoyuan Shien (TW)

(21) Appl. No.: 12/461,232

(22) Filed: Aug. 5, 2009

(30) Foreign Application Priority Data
Oct. 24, 2008 (TW) 97140998

(51) Int. Cl. B32B 3/30; B29C 45/14; B32B 17/10; B32B 27/36

(52) U.S. Cl. 428/172; 264/267; 264/101; 428/426; 428/412

(57) ABSTRACT

A plastic product includes a plastic base, a plurality of glass fibers, a hard coat layer, and an adhesive layer. The glass fibers are fully buried within the plastic base. The hard coat layer is attached onto the plastic base with the aid of the adhesive layer.

### RELATED APPLICATIONS

This application claims priority to Taiwan Application Serial Number 97140998, filed Oct. 24, 2008, which is herein incorporated by reference.

### BACKGROUND

1. Field of Invention

The present invention relates to a method of molding a plastic, and more particularly to a method of inject-molding and a plastic product fabricated by the method.

2. Description of Related Art

As the markets of consumer electronics become more and more competitive, demands for better looking electronics increase along with performance requirements, prompting manufacturers seeking innovation on ways to enhance the outer appearance of their products.

Currently, housing of an electronic product is used mainly to shield off dust, however, as consumers are no longer satisfied with a purely functional housing design, manufacturers are now turning to fashion industry for ideas to help innovate a housing that not only is sleek-looking but with quality as well.

Since the plastic material itself is not rigid enough to render its product resistant to scratches, hence to confer a plastic product a glossy appearance, additional painting process on the surface is a must. However, the painting process is not only unfriendly to the environment, but also time consuming and cost ineffective; and often results in an unacceptable low product yield.

### SUMMARY

In view of the above, one objective of this invention aims to provide an improved method of molding a plastic, comprising the step of transfer molding a hard coat layer to a plastic product by use of a release film and thereby avoiding the possible problems caused by the conventional paint treatment.

In one aspect of the present invention, a plastic molding method is provided. The method includes steps of:
(a) providing a mold;
(b) heating the mold;
(c) attaching a film onto an inner side of the mold, wherein the film comprises in sequence from the inner side of the mold towards the inner volume of the mold, a base layer, a release layer, a hard coat layer and an adhesive layer;
(d) injecting a plastic material toward and onto the inner side of the mold thereby molding the plastic material into a plastic product;
(e) cooling the mold rapidly; and
(e releasing the plastic product from the mold while allowing the hard coat layer remained adhered onto the plastic product via the adhesive layer.

In a second aspect of this invention, there is provided a plastic product fabricated by the forgoing method.

In a third aspect of the invention, a plastic product comprises a plastic base, a plurality of glass fibers, a hard coat layer and an adhesive layer is provided. The plurality of glass fibers are embedded within the plastic base, and the adhesive layer adheres the hard coat layer onto the plastic base.

These and other features, aspects, and advantages of the present invention will become better understood with reference to the following description and appended claims.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1 to 4 are schematic view of various stages of a plastic molding method in accordance with one embodiment of this invention;

FIG. 5 is an enlarged view of a portion of FIG. 2;

FIG. 6 is a cross sectional view of a plastic product fabricated by the steps described in one embodiment of this invention; and

FIG. 7 is a perspective view of the plastic product illustrated in FIG. 6.

### DETAIL DESCRIPTION OF ILLUSTRATED EMBODIMENTS

Reference will now be made in detail to the preferred embodiments of the invention, examples of which are illustrated in the accompanying drawings. Wherever possible, the same reference numbers are used in the drawings and the description to refer to the same or like parts.

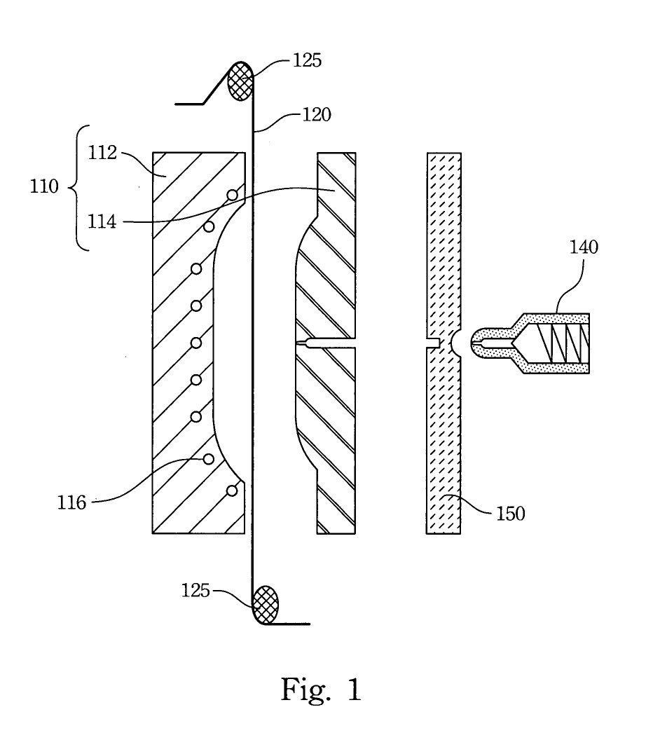

In view of the problems of the conventional paint process step for the manufacture of plastic products, embodiments of this invention aims to produce a molded plastic product with a highly glossy surface and a hard coat layer in one shot molding by applying an In Mold Roller/Reprint (IMR) technique in Rapid Heat Cycle Molding (RHCM) process. This invention is explained in further detail by making references to FIGS. 1 to 7. However, it is to be noted that some features in the figures are not drawn in proper proportions; in other words, sizes of these features may have been reduced or enlarged for illustrative purpose.

Referring to FIG. 1, a mold 110 is provided by the manufacturer, the mold 110 may be a mold used in a typical injection molding process. For example, the mold 110 may comprise a female mold 112 and a male mold 114. Further, the mold 110 may be at ambient temperature, such as about 30° C.

The mold 110 is heated to a suitable temperature, specifically, it may be heated by use of a steam, to a temperature between about 120° C. to about 140° C. One of skilled persons in this art should realize that the afore-mentioned heating step and the temperature range are for illustrative purpose only, and may vary in accordance with the heating means adopted by each specific embodiment.

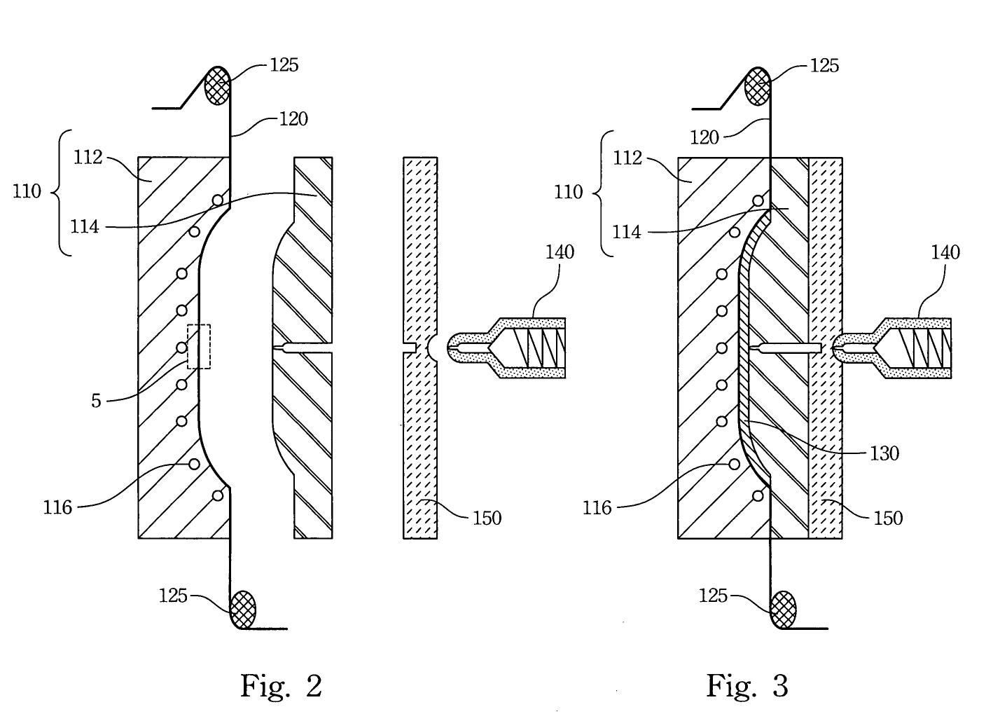

Reference is now made to FIG. 2, in which a thin film 120 is attached onto the inner side of the mold 110. Specifically, a pair of rollers 125 roll the film 120 to a proper position, then vacuum holes 116 on the mold 110, such as the female mold 112, vacuum attach the film 120 onto the inner side of the mold 110 (such as the female mole 112).

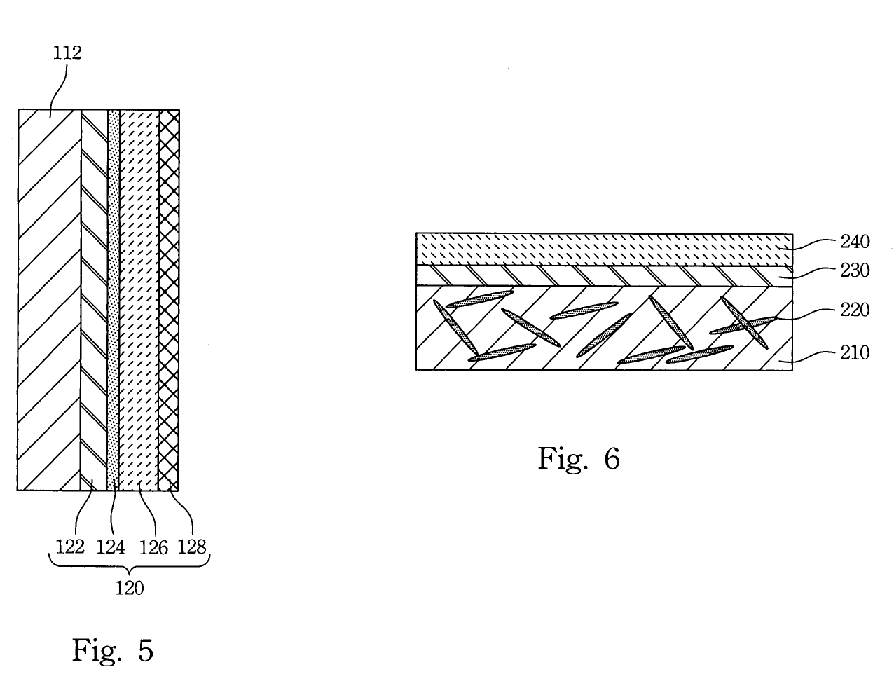

FIG. 5 is an enlarged view of a portion of FIG. 2. As shown in FIG. 5, the film 120 comprises in sequence from the inner side of the mold 110 (e.g., female mold 112) towards the inner volume of the mold 110, a base layer 122, a release layer 124, a hard coat layer 126 and an adhesive layer 128; wherein the release layer 124 is for separating the hard coat layer 126 from the base layer 122, such that the hard coat layer 126 remains adhered onto the plastic product 130 via the adhesive layer 128. Specifically, the film 120 may be any film commonly used in IMR; the film 120 includes, but is not limited to, polyethylene terephthalate. (PET) and an UV curable coating material. To confer the film 120 with the ability of resisting high temperature operations in RHCM, manufacturer may elect to leave out materials therein that are not resistant to high temperature operations. For example, the film 120 of this invention may not comprise any ink layer, in contrast to the known film, which would comprise an ink layer.

Referring to FIG. 3, a plastic material is now injected toward the inner side of the mold 110, and is compressed molded into a plastic product 130. Specifically, a suitable plastic material is injected from a nozzle 140 of an injection-molding machine and through an ejection return plate 150 into the inner volume defined by both female mold 112 and male mold 114.

The suitable plastic material may be at least one material selected from the group consisting of polystyrene (PS), acrylonitrile-butadience styrene (ABS), polycarbonate (PC), poly(methyl methacrylate) (PMMA), nylon, glass fiber (GF) and combinations thereof. For example, the plastic material may be a compound plastic composed by two different materials such as ABS and PC; nylon and GF; or a compound plastic composed by three different materials such as ABS, PC and GF. Preferably, the compound plastic comprises about 15% by weight of glass fibers. The amount of GF in the compound plastic may vary in accordance with the actual need in the final product; however, a range between about 30% (wt %) to about 40% (wt %) may be used in this invention.

The mold 110 is then subsequently cooled to a temperature about 30° C. with the aid of water (at ambient temperature) or ice-cold water (at iced cold temperature). It is to be noted that the cooling manner described herein is merely an example; there are many other ways to cool the mold 110 to the desired temperature, and any skilled person in this art would know how to choose a proper means for cooling the mold in accordance with the actual situation.

The term “ambient temperature” herein represents normal room temperature that ranges between about 15° C. to about 25° C. As to “iced cold temperature” herein, it represents a temperature that is lower than the ambient temperature, such as a temperature below about 15° C.

It is to be noted that the term “about” is used to slightly modify the indicated numerical number, without substantially changing the indicated amount. For example, a temperature about 15° C., should be interpreted as a temperature that is slightly below or above 15° C., for example, water at a temperature of about 15° C. includes water at a temperature slightly above or below 15° C.

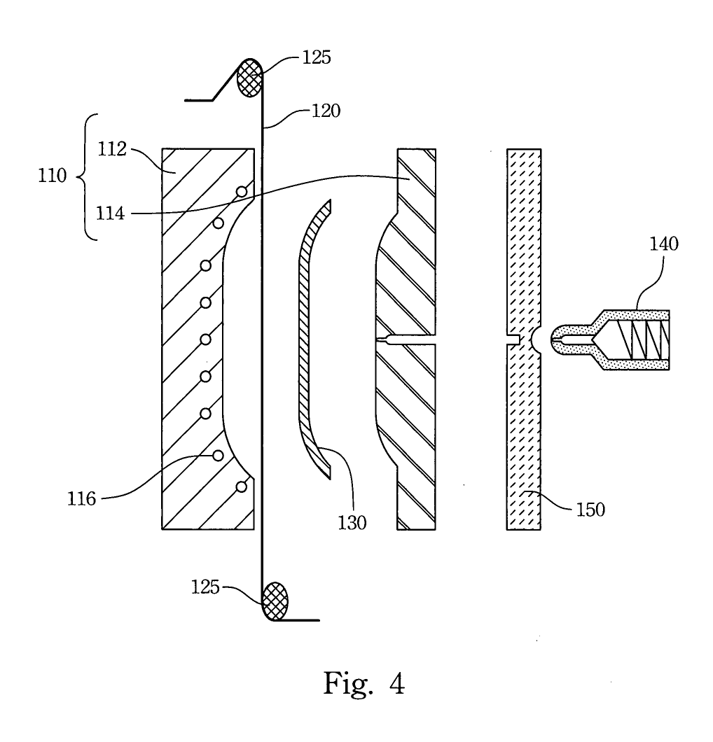

Reference in mow made to FIG. 4, in which the plastic product 130 is separated from the mold 110. The release layer 124 is sacrificed during separation so as to separate hard coat layer 126 from the base layer 122. After separation, the hard coat layer 126 remains adhered onto the plastic product 130 via the adhesive layer 128 and thereby preventing the glossy surface of the plastic product from possible damages such as scratches.

It should be noted that the steps described in this invention may be performed in other suitable order, unless particularly point out to the contrary. For example, the step of heating the mold 110 may be carried out before attaching the film 120 onto the inner side of the mold 110, or these two steps may be carried out simultaneously, as long as they are completed before the injection step. In one example, after the film is attached onto the inner side of the mold 110, the mold 110 has been heated to about 90° C.

In a second aspect of this invention, there is proved a plastic product manufactured by the method described above. FIG. 6 is a cross sectional view of a plastic product manufactured by the steps described in one embodiment of this invention. The plastic product comprises a plastic base 210, a plurality of glass fibers 220, a hard coat layer 240 and an adhesive layer 230. In this example, the plurality of glass fibers are fully buried within the plastic base 210, and the hard coat layer 240 is attached onto the plastic base 210 with the aid of the adhesive layer 230.

The plastic product in this example is molded at a relatively high temperature, such as about 120° C. to 140° C., plastic material that comes into contact with the mold will not solidify immediately right after the contact, thereby enabling glass fibers 220 to be fully buried within the still un-solidified plastic base, and conferring the plastic product a glossy appearance. Furthermore, the hard coat layer 240 is attached onto the plastic base with the aid of the adhesive layer 230 in contrast to the conventional painting process, in which organic solvent is evaporated and leaving behind a glossy layer of a paint on the surface. Without using organic solvent in the manufacturing process, the plastic product manufactured in this invention would comply relevant Articles and/or Regulations in European Union (EU).

Specifically, the hard coat layer 240 may be any known hard coat layer commonly used in IMR process, for example, PET or a UV coating material. To accommodate high temperature operations generally required in practicing IMR process, the manufacturer may take out materials between the hard coat layer 240 and the plastic base 210. In this invention, an ink layer is omitted.

The plastic base may be made from a material selected from the group consisting of polystyrene (PS), acrylonitrile-butadience styrene (ABS), polycarbonate (PC), poly(methyl methacrylate) (PMMA), nylon, glass fiber and combinations thereof. For example, the plastic material may be a compound plastic composed by two different materials such as ABS and PC; nylon and GF; or a compound plastic composed by three different materials such as ABS, PC and GF. It should be noted that the materials described herein are for illustrative purpose only, and the scope of this invention is not limited to the illustrated materials. Any skilled person in the relevant art may select a proper material to practice this invention without undue experimentation.

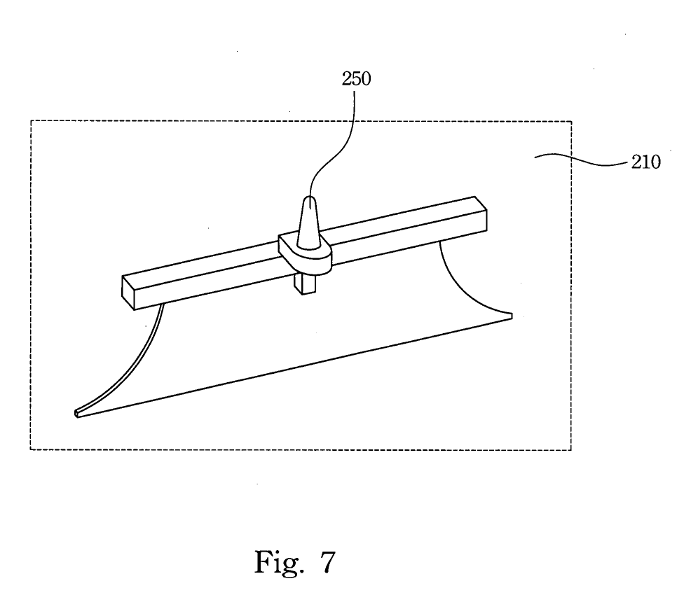

FIG. 7 is a perspective view of the plastic product in FIG. 6. The plastic product manufactured by the method described herein is characterized in having a conical sprue 250, disposed on the plastic base 210. It should be noted that the sprue 250 may be of any shape, depends on types of the adopted injection-molding machine. Any skilled person in the relevant art may select a proper way to practice this invention by creating a sprue on the plastic product without undue experimentation.

The foregoing description of various embodiments of the invention has been presented for purpose of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

We claim:

1. A plastic molding method, comprising:
providing a mold;
heating the mold;
attaching a film onto an inner side of the mold, wherein the film comprises in sequence from the inner side of the mold towards the inner volume of the mold, a base layer, a release layer, a hard coat layer and an adhesive layer;
injecting a plastic material toward and onto the inner side of the mold. thereby molding the plastic material into a plastic product;
cooling the mold; and
releasing the plastic product from the mold while allowing the hard coat layer remained adhered onto the plastic product via the adhesive layer.

2. The method of claim 1, wherein heating the mold comprises: heating the mold by use of steam.

3. The method of claim 1, wherein heating the mold comprises:
heating the mold by use of steam to a temperature of about 120° C. to about 140° C.

4. The method of claim 1, wherein attaching the film onto the inner side of the mold comprises:
allowing the film to be vacuum attached onto the inner side of the mold.

5. The method of claim 1, wherein attaching the film onto the inner side of the mold comprises:
rolling the film with a pair of rollers.

6. The method of claim 1, wherein the hard coat layer is made from polyethylene terephthalate (PET) or an UV coating material.

7. The method of claim 1, wherein the plastic material is selected from the group consisting of polystyrene (PS), acrylonitrile-butadience styrene (ABS), polycarbonate (PC), poly(methyl methacrylate) (PMMA), nylon, glass fiber and, combinations thereof.

8. The method of claim 1, wherein the plastic material comprises a plurality of glass fibers.

9. The method of claim 8, wherein the plastic material comprises about 15% by weight of the glass fibers.

10. The method of claim 1, wherein cooling the mold comprises:
cooling the mold by use of water at ambient temperature.

11. The method of claim 1, wherein cooling the mold comprises:
cooling the mold by use of ice-cold water.

12. The method of claim 1, wherein cooling the mold comprises:
cooling the mold to about 30° C. by use of water at ambient temperature.

13. The method of claim 1, wherein cooling the mold comprises:
cooling the mold to about 30° C. by use of ice-cold water.

14. A plastic product, comprising:
a plastic base;
a plurality of glass fibers fully buried within the plastic base;
a hard coat layer; and
an adhesive layer for adhering the hard coat layer and the plastic base.

15. The plastic product of claim 14, wherein the plastic base is made from a material selected from the group consisting of polystyrene (PS), acrylonitrile-butadience styrene (ABS), polycarbonate (PC), poly(methyl methacrylate) (PMMA), nylon, glass fiber and combinations thereof.

16. The plastic product of claim 14, wherein the hard coat layer is made from polyethylene terephthalate (PET) or an UV curable material.

17. The plastic product of claim 14, further comprising:
a conical sprue disposed on the plastic base.
